(19) United States
(12) Patent Application Publication
(10) Pub. No.: US 2023/0124448 A1
(43) Pub. Date: Apr. 20, 2023

(54) WHEELSET BEARING FOR A RAIL VEHICLE, AND RAIL VEHICLE

(71) Applicant: Schaeffler Technologies AG & Co. KG, Herzogenaurach (DE)

(72) Inventors: Bert ROSENHEINRICH, Dittelbrunn (DE); Guenter AUMUELLER, Zeil/Main (DE); Heinrich HOFMANN, Schweinfurt (DE); Thomas STAHL, Poppenhausen (DE)

(73) Assignee: Schaeffler Technologies AG & Co. KG, Herzogenaurach (DE)

(21) Appl. No.: 17/914,482

(22) PCT Filed: Feb. 17, 2021
(86) PCT No.: PCT/DE2021/100157

§ 371 Date: Sep. 26, 2022

(30) Foreign Application Priority Data
Mar. 30, 2020 (DE) 102020108770.5

(51) Int. Cl. F16C 19/18; F16C 19/50; F16C 33/58; B60B 27/00

(52) U.S. Cl. CPC F16C 19/184; F16C 19/505; F16C 33/585; B60B 27/0078; B60B 27/0005; B60B 27/0094; F16C 2240/34; F16C 2326/10; B60B 2380/12; B60B 2380/772

(57) ABSTRACT

A wheelset bearing for a rail vehicle includes a rolling bearing assembly (7) with three bearing rings (4, 8, 9), specifically two inner rings (4, 8) provided for connection to a wheelset shaft (2) and one outer ring (9) provided for connection to a housing (6). The rolling bearing assembly (7) is designed as a quadruple-row angular contact ball bearing in an O arrangement, and two rolling element rows (16, 17) are provided contacting a first inner ring (4) in order to absorb axial forces in a first direction and two rolling element rows (18, 19) are provided contacting a second inner ring (8) in order to absorb forces in the opposite axial direction. A rail vehicle with such an arrangement is also provided.

### CROSS-REFERENCE TO RELATED APPLICATIONS

This application is the U.S. National Phase of PCT Appln. No. PCT/DE2021/100157, filed Feb. 17, 2021, which claims the benefit of German Patent Appln. No. 10 2020 108 770.5, filed Mar. 30, 2020, the entire disclosures of which are incorporated by reference herein.

### TECHNICAL FIELD

The disclosure relates to a wheelset bearing for use in a rail vehicle. The disclosure further relates to a rail vehicle having at least two one such wheelset bearing.

### BACKGROUND

Such a wheelset bearing is known, for example, from DE 10 2006 015 289 A1. The known wheelset bearing is a double-row tapered rolling bearing with two inner rings and a single outer ring. Furthermore, in the wheelset bearing according to DE 10 2006 015 289 A1, a support ring is provided for axially supporting the inner rings.

A further wheelset bearing designed as a tapered rolling bearing is known from DE 10 2017 119 249 A1. In this case, a generator unit is provided on the wheelset bearing. The stator of the generator unit is connected to a cover that covers the wheelset bearing on one end of the wheelset shaft.

DE 101 28 861A1 discloses a wheelset bearing designed as a double-row cylindrical rolling bearing. A damping element is arranged between the cylindrical rolling bearing and the wheelset shaft of the rail vehicle, so that vibrations emanating from the rail wheel only reach the rolling bearing, i.e., the cylindrical rolling bearing, in a damped form.

From EP 2 276 658 B1, a measurement bearing for a wheelset bearing of a rail vehicle is known. EP 2 276 658 B1 mentions, inter alia, ball bearings, barrel rolling bearings and needle bearings as conceivable rolling bearing types.

DE 10 2017 112 338 A1 describes a double-row angular contact ball bearing.

DE 10 2007 049 982 A1 discloses a rolling bearing having two angular contact ball bearings arranged obliquely in an O arrangement.

DE 10 2013 224 545 A1 describes a wheel bearing of a vehicle having four angular contact ball bearing units.

DE 10 2006 025 551 A1 discloses a multi-row axially pretensioned angular contact ball bearing and a method for its manufacture.

### SUMMARY

The object of the disclosure is to specify a wheelset bearing for a rail vehicle which has been further developed compared with the aforementioned prior art and is characterized by a particularly favorable ratio between possible service life and maintenance expenditure.

According to the disclosure, this object is achieved by a wheelset bearing having one or more of the features provided herein. The wheelset bearing comprises a rolling bearing assembly with three bearing rings, specifically two inner rings provided for connection to a wheelset shaft and one outer ring provided for connection to a housing. The rolling bearing assembly is designed as a quadruple-row angular contact ball bearing in an O arrangement, wherein two rolling element rows are provided contacting a first inner ring in order to absorb axial forces in a first direction and two rolling element rows are provided contacting a second inner ring in order to absorb forces in the opposite axial direction. In this case, either the inner rings or the outer ring have a single-shoulder rolling element raceway for receiving each rolling element row. The single-shoulder rolling element raceway is bounded by a radial line perpendicular to the central axis and through a rolling element center point of each rolling element in rolling element row, as seen in cross-section along a central axis through the wheelset bearing. Starting from the radial line and from the center point of the rolling element, the rolling element raceway extends in the direction of the shoulder over an angle in the range of 35° to 75° up to a reference point with a constant radius. From the reference point, the rolling element raceway follows a tangent applied to the rolling element raceway at the reference point.

In particular, the rolling element raceway extends, starting from the radial line and from the center point of the rolling element, in the direction of the shoulder over an angle in the range of 35° to 50° up to the reference point.

The rolling element raceway is thus, seen in cross-section along a central axis through the wheelset bearing, formed from the reference point of a tangent applied to the rolling element track at the reference point. The rolling element raceway that guides the rolling elements thus has a constant radius in the area between the radial line and the reference point and no constant radius in the outer area in the direction of the shoulder, but a tangential run out following the applied tangent. This ensures that edge stresses are avoided with higher axial loads, such as can occur in railway applications; for example, due to rail joints, since the contact ellipse does not “run up” on a sharp-edged transition, but can spread out elliptically in the tangential run out. Edge stresses can thus be avoided. This improves the friction behavior and extends the service life of the wheelset bearing. In particular, the tangential outlet from the reference point is at least 2 mm long, in particular 2 to 10 mm long.

Multi-row angular contact ball bearings in an O arrangement are generally characterized by the fact that the pressure lines as a whole describe a geometric shape similar to the letter “O”; more precisely, in the form of a rhombus. Multi-row bearings in an X arrangement must also be distinguished from multi-row bearings in an O arrangement, in which the pressure lines intersect—as in the letter “X”. In the present case, i.e., in the quadruple-row rolling bearing assembly, two nested rhombuses are formed by the pressure lines of the bearing.

This is based on the consideration that wheelset bearings for rail vehicles require long maintenance intervals; for example, maintenance-free operation over three million kilometers. Among other things, the grease service life is noteworthy, especially given the long-term trend for increasing speed limits in rail vehicles. The service life of the grease depends, among other things, on the temperature in the wheelset bearing, which is significantly influenced by the friction in the bearing.

Proceeding from these considerations, the quadruple-row angular contact ball bearing of the wheelset bearing according to the present disclosure provides a type of rolling bearing characterized by particularly low friction compared to cylindrical rolling bearings and tapered rolling bearings. Surprisingly, it has been shown that, despite the lack of line contacts due to the design, as is the case with tapered rolling bearings and cylindrical rolling bearings, a load capacity that is sufficient for use in rail vehicles can be achieved using the available space. In a preferred embodiment, there is no intermediate ring between the inner rings of the wheelset bearing. Rather, the inner rings preferably abut one another directly.

With regard to quadruple-row angular contact ball bearings in an O arrangement, which are also referred to as twin tandem bearings, the technical background can be found in documents DE 84 05 082 U1, DE 103 31 936 B4, DE 198 39 481 A1 and DE 10 2017 112 338 A1. However, all the cases mentioned relate to bearings for motor vehicles.

The two rolling element rows are formed with particularly small, in particular no, axial play. This means that the outer rows of rolling elements are preferably formed by rolling elements, i.e., balls, the diameter of which is at least 5% and at most 25% larger, preferably 12 to 17% larger, than the diameter of the rolling elements of the two inner rows of rolling elements. These size ratios contribute to an even compression at a low level, wherein a uniform contact pattern is provided in normal operation, i.e., when used in a rail vehicle.

Tailored for use in rail vehicles, the wheelset bearing according to the disclosure is designed primarily for absorbing radial forces and to a lesser extent for absorbing axial forces. Here, radial and axial forces can be absorbed by all rolling elements rows. In a preferred embodiment, the contact angle of the two outer rolling element rows does not deviate from the contact angle of the two inner rolling element rows by more than 6°. This means that each rolling element row can provide support in the radial direction and support in the axial direction in approximately the same ratio. The contact angle of each rolling element row is preferably at least 24° and at most 36°, for example uniformly 30°.

In a stress-appropriate and assembly-friendly manner, groove-shaped rolling element raceways are preferably formed by the inner rings, whereas the rolling element raceways of the outer ring are designed with one shoulder and thus only offer support in a single axial direction. In the opposite axial direction, on the other hand, the raceway of the outer ring merges into a cylindrical inner peripheral surface of the outer ring, which means a tangential run out of the rolling element raceway. However, an embodiment is also possible in which the outer ring forms groove-shaped rolling element raceways, whereas the rolling element raceways of the inner rings are designed as single-shouldered. Likewise, embodiments can be realized in which the outlet of the rolling element raceway, i.e., the surface section opposite the shoulder of the raceway, describes a conical surface, wherein the corresponding cone widens in the direction of the end face of the outer ring closest to the rolling element raceway.

In terms of maximizing the service life, it has been found to be advantageous if the axial play of the two outer rolling element rows is less than the axial play of the two inner rolling element rows of the twin tandem bearing. In particular, there is no axial play on the two outer rolling element rows, whereas the axial play on the two inner rolling element rows is more than 10 pm, wherein a temperature of the wheelset bearing of 20° C. is assumed and the wheelset bearing is not yet mounted on a wheelset shaft at the place of use. Due to the axial play that decreases from the inner rolling element rows to the outer rolling element rows, the arrangement of rolling elements is also particularly suitable for absorbing tilting loads.

When the wheelset bearing is at operating temperature, i.e., at temperatures greater than 50° C., which usually occur when the wheelset bearing is in operation when it is mounted on a wheelset shaft, the axial play of the outer row of rolling elements and the inner row of rolling elements is 0, so that an even load on all rolling element rows results.

The rolling elements of each rolling element row can each be guided through a cage in a manner known per se. Likewise, the entire rolling bearing assembly can be sealed in a manner known per se, wherein low-friction seals are preferably used. A grease is preferably used as the lubricant. Thanks to the point contacts between the rolling elements and the bearing rings, there is only a moderate increase in temperature when the wheelset bearing is in operation, which means that the grease is less stressed.

The reduced shear stress on the lubricant due to the point contacts compared to line contacts also plays a significant role, which also benefits the grease service life. In this context, reference is also made to the standard DIN 51825 “Lubricants —Lubricating greases K — Classification and requirements”, which applies to lubricating greases for the lubrication of rolling bearings, plain bearings and sliding surfaces.

### BRIEF DESCRIPTION OF THE DRAWINGS

In the following, an exemplary embodiment of the disclosure is explained in more detail by means of a drawing. In the figures:

FIG. 1 shows a wheelset bearing in a sectional view,

FIG. 2 shows a detail of the wheelset bearing.

### DETAILED DESCRIPTION

A wheelset bearing, generally designated 1, is used to support a wheelset shaft 2 in a supporting construction 3 of a rail vehicle (not shown separately). The wheelset bearing 1 comprises a rolling bearing assembly 7 with two inner rings 4, 8 and a single outer ring 9. An end cap 11, which is screwed to the front end of the wheelset shaft 2 with screws 12, supports the entire rolling bearing assembly 7 in an axial direction. The screws 12 are inserted through bores 14 in the end cap 11. Seals for sealing the rolling bearing assembly 7 on both sides are designated with 13. The rolling bearing assembly 7 is lubricated with a grease as a lubricant.

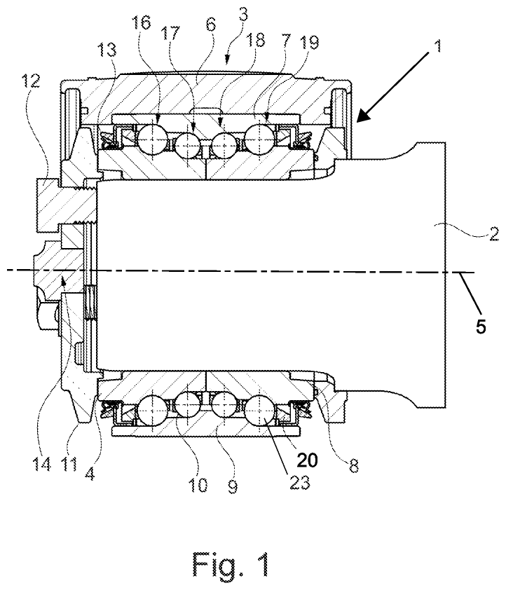

The rolling bearing assembly 7 is constructed as a quadruple-row angular contact ball bearing in the form of a twin tandem bearing. The individual rolling element rows are denoted by 16, 17, 18, 19. The rolling element rows 16, 17 roll on the inner ring 4 on the left in the arrangement according to FIG. 1, and the rows of rolling elements 18, 19 on the bearing channel ring 8 on the right. The rolling element raceways of the inner rings 4, 8 are denoted by 21, the total of four rolling element raceways of the outer ring 9 are denoted by 22. The rolling elements 10, 23 of each rolling element row 16, 17, 18, 19 are guided in a cage 20.

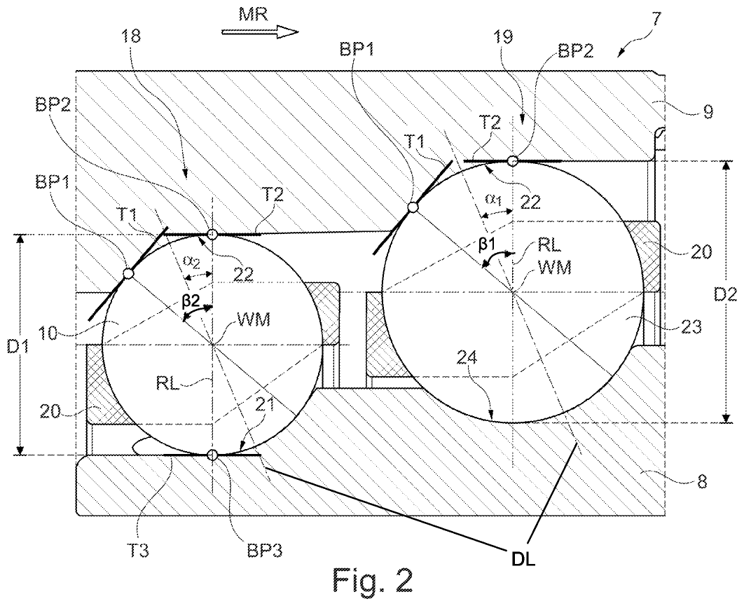

The rolling element rows 16, 17 support the wheelset shaft 2 in relation to the bearing housing 6 in a first axial direction. The rolling element rows 18, 19 are used for support in the opposite axial direction. The entire rolling bearing assembly 7 is mirror-symmetrical to a plane placed between the bearing races 4, 8. As can be seen in particular from FIG. 2, the diameter of the rolling elements 10 of the two inner rolling element rows 17, 18, denoted by D1, is smaller than the diameter of the rolling elements 23 of the two outer rolling element rows 16, 19, denoted by D2. By definition, a circle drawn through all the rolling element centers WM of a rolling element row 16, 17, 18, 19 represents the pitch circle of the relevant rolling element row 16, 17, 18, 19. The pitch circle diameter of the inner rolling element rows 17, 18 is smaller than the pitch circle diameter of the outer rolling element rows 16, 19.

The total of four raceways 21 provided by the bearing inner rings 4, 8 are each designed in the form of grooves. In contrast to this, the rolling element raceways 22 of the outer ring 9 are each designed as single-shoulder raceways with the shape of half a groove. In FIG. 2, different tangents T1, T2 are applied to the rolling element raceways 22, which are each placed through a reference point BP1, BP2. In any case, the reference point BP2 lies on a radial line RL, which is laid through the rolling element center point WM and lies in a plane to which the central axis 5 of the rolling bearing assembly 7 represents a surface normal. The tangent T2, on which the reference point BP2 lies, is aligned parallel to the axis of rotation of the rolling bearing assembly 7, i.e., to the central axis 5 of the wheelset shaft 2. The single-shouldered shape of the rolling element raceway 22 is expressed by the fact that all tangents which can be applied to the raceway 22 are inclined in one and the same sense with respect to the central axis 5 or, in the extreme case, which is the case with the tangent T2, are spaced parallel from the central axis 5. The tangent T1 on which the reference point BP1 lies is close to the shoulder. Starting from the radial line RL and the rolling element center point WM, the reference point BP1 lies here on a line which encloses an angle β1, β2 of approximately 48° with the radial line RL.

Starting from the reference point BP1, the rolling element raceway 22 follows a tangent T1 applied to the rolling element raceway 22 at the reference point BP1. The rolling element raceway 22, which guides the rolling elements 10, 23, does not have a constant radius in the outer area in the direction of the shoulder, but instead has a tangential run out following the tangent T1. This ensures that edge stresses are avoided with higher axial loads, such as can occur in railway applications; for example, due to rail joints, since the contact ellipse does not “run up” on a sharp-edged transition, but can spread out elliptically in the tangential run out. The tangent T2 is provided on the other side of the rolling element track 22, which dictates the course of the rolling element track 22 and is also intended to enable the contact ellipse to spread unhindered. Edge stresses can thus be avoided. This improves the friction behavior and extends the service life of the wheelset bearing.

The rolling bearing rows 17, 18 are also located in the area of the inner rings 4, 8 in single-shoulder rolling bearing raceways 21. A tangent T3 is created at the reference point BP3, which defines the course of the rolling element raceway 21 and which is also intended to enable the contact ellipse to spread unhindered. Only the rolling bearing rows 16, 19 are in the area of the inner rings 4, 8 in two-shouldered rolling bearing raceways 24.

According to the usual definition, pressure lines denoted by DL run through the rolling element centers WM and the contact points on the bearing rings 4, 8, 9. The contact angles denoted by α1, α2, which are given on the outer rolling element rows 16, 19 and on the inner rolling element rows 17, 18, are uniformly 30° in the exemplary embodiment. The assembly direction designated MR indicates the direction in which the outer ring 9 is to be displaced relative to the inner ring 8 when the rolling bearing assembly 7 is assembled. After assembly, the rolling elements 23 of the outer rolling element rows 16, 19 are arranged without play in the axial direction between the inner ring 4, 8 and the outer ring 9. On the other hand, the inner rolling element rows 17, 18 have a play of more than 10 μm, which is also related to the axial direction.

### LIST OF REFERENCE SIGNS

1 Wheelset bearing

2 Wheelset shaft

3 Supporting construction

4 Bearing inner ring

5 Central axis

6 Bearing housing

7 Rolling bearing assembly, quadruple-row angular contact ball bearing

8 Bearing inner ring

9 Bearing outer ring

10 Rolling element

11 End cap

12 Screw

13 Seal

14 Hole in the end cap

15

16 Rolling element row

17 Rolling element row

18 Rolling element row

19 Rolling element row

20 Cage

21 Inner ring raceway

22 Outer ring raceway

23 Rolling element

24 Inner ring track

α1, α2 Contact angle

β, β2 Angle

BP1, BP2, BP3 Reference point

D1, D2 Rolling element diameter

DL Pressure line

MR Assembly direction

RL Radial line

T1, T2, T3 Tangent

WM Rolling element center

1. A wheelset bearing for a rail vehicle, the wheelset bearing comprising:
a rolling bearing assembly including first and second inner rings provided for connection to a wheelset shaft and one outer ring provided for connection to a housing;
the rolling bearing assembly is configured as a quadruple-row angular contact ball bearing in an O arrangement, including two rolling element rows that contact the first inner ring in order to absorb axial forces in a first direction, and two rolling element rows that contact the second inner ring in order to absorb forces in an opposite axial direction; and
either the first and second inner rings or the outer ring for receiving each said rolling element row is/are formed with a single-shoulder rolling element raceway, the single-shoulder rolling element raceway, viewed in cross-section along a central axis through the wheelset bearing, is bounded by a radial line extending perpendicular to the central axis through a rolling element center of each rolling element of the rolling element row, and the rolling element raceway extends from the radial line and from the rolling element center in a direction of a shoulder over an angle in a range from 35 to 75° to a reference point with a constant radius, and the rolling element raceway is formed from the reference point following a tangent applied to the rolling element raceway at the reference point.

2. The wheelset bearing according to claim 1, wherein a the diameter of the rolling elements of two outer ones of the rolling element rows is at least 5% and at most 25% larger than a diameter of the rolling elements of two inner ones of the rolling element rows.

3. The wheelset bearing according to claim 2, wherein a contact angle of the two outer rolling element rows deviates from the contact angle of the two inner rolling element rows by no more than 6°.

4. The wheelset bearing according to claim 3, wherein the contact angle of each said rolling element row is at least 24° and at most 36°.

5. The wheelset bearing according to claim 4, wherein all of the rolling element rows of the rolling bearing assembly have a uniform contact angle of 30°.

6. The wheelset bearing according to claim 1, wherein the outer ring has the single-shoulder rolling element raceway for each said rolling element row.

7. The wheelset bearing according to claim 1, wherein an axial play of two outer ones of the rolling element rows is less than an axial play of two inner ones of the rolling element rows.

8. The wheelset bearing according to claim 7, wherein there is no axial play on two outer ones of the rolling element rows.

9. The wheelset bearing according to claim 7, wherein an axial play on two inner ones of the rolling element rows is more than 10 μm.

10. A rail vehicle comprising at least one wheelset shaft on which at least one said wheelset bearing according to claim 1 is arranged.

11. A wheelset bearing, comprising:
a rolling bearing assembly including first and second inner rings provided for connection to a shaft and one outer ring provided for connection to a support;
first inner and first outer rolling element rows of rolling elements that contact the first inner ring to absorb axial forces in a first direction and second inner and second outer rolling element rows of rolling elements that contact the second inner ring to absorb forces in an opposite axial direction, the rolling bearing assembly is configured as a quadruple-row angular contact ball bearing in an O arrangement; and
either the first and second inner rings or the outer ring for receiving each said rolling element row is/are formed with single-shoulder rolling element raceways, the single-shoulder rolling element raceways, viewed in cross-section along a central axis through the wheelset bearing, are each bounded by a radial line extending perpendicular to the central axis through a rolling element center of each rolling element of the respective rolling element rows, and the rolling element raceway extends from the radial line and from the rolling element center in a direction of a respective shoulder over an angle in a range from 35 to 75° to a reference point with a constant radius, and the respective rolling element raceway is formed from the reference point following a tangent applied to the rolling element raceway at the reference point.

12. The wheelset bearing according to claim 11, wherein a diameter of the rolling elements of the two outer rolling element is at least 5% and at most 25% larger than a diameter of the rolling elements of the two inner rolling element rows.

13. The wheelset bearing according to claim 12, wherein a contact angle of the two outer rolling element rows deviates from the contact angle of the two inner rolling element rows by no more than 6°.

14. The wheelset bearing according to claim 13, wherein the contact angle of each said rolling element row is at least 24° and at most 36°.

15. The wheelset bearing according to claim 14, wherein all of the rolling element rows of the rolling bearing assembly have a uniform contact angle of 30°.

16. The wheelset bearing according to claim 11, wherein the outer ring has the single-shoulder rolling element raceways for each said rolling element row.

17. The wheelset bearing according to claim 11, wherein an axial play of the two outer rolling element rows is less than an axial play of the two inner rolling element rows.

18. The wheelset bearing according to claim 17, wherein there is no axial play on the two outer rolling element rows.

19. The wheelset bearing according to claim 17, wherein an axial play on the two inner rolling element rows is more than 10 μm.
